(19) United States
(12) Patent Application Publication
(10) Pub. No.: US 2009/0321282 A1
(43) Pub. Date: Dec. 31, 2009

(54) "Paint n' Carry"

(76) Inventor: Nada Asmaro, Warren, MI (US)

Correspondence Address: Nada Asmaro, 1988 Waltz, Warren, MI, 48091, US

(21) Appl. No.: 12/380,742

(22) Filed: Mar. 4, 2009

Related U.S. Application Data
(60) Provisional application No. 61/069,325, filed on Mar. 14, 2008.

(51) Int. Cl. B44D 3/04

(52) U.S. Cl. 206/1.8

(57) ABSTRACT

A tray with a handle that could hold all of your art supplies to paint on, nothing to put out and nothing to put away, and you can take it wherever you want to paint.

### FIELD OF THE INVENTION

The field is in the art supply products, it would make painting more fun, convenient, easy to paint alone, or with your kids or friends or taking painting classes.

### BACKGROUND OF THE INVENTION

Painting is the most beautiful way to express your feelings, thoughts, emotions painting may revoke emotional, intellectual discussions, sensual feelings, spiritual response, calms people down and relax them, it shows creative expressions, it could be a form of escapism, an opportunity to create their ideal world, its an expression of their emotions, or to record something they've seen and painting can be very therapeutic, express their thought and feelings or try to re-create the beauty that exist from within, also for fun, family time to spend family time together, creativity never get bored as there is always that feeling that there is something waiting to be done it gives them inspiration and creativity to express themselves when words do not come easily.

### SUMMARY OF THE INVENTION

Why people put off painting? one of the reasons is you have to get all of painting supplies out, get the water containers, get the brushes out, get the palettes out, get the paper towels and so many other supplies, by the time you get everything out you are already exhausted, and then the thought of having to put everything away and clean up everything discourages people from paintings, also with todays busy schedules, deadlines and appointments, work the next day, running errands, people put off painting because of these legitimate reasons.

A lot of people who love to paint or painted before procrastinate to paint because the idea of putting everything out, get the water containers, get the brushes, get the paints, get this and that discourages them from going back and forth especially if you have knee problems or any medical health issues.

The thought of having to clean up and putting everything back also discourages people to paint, but with this (paint n carry) you only make one trip to fill your jars with water.

Also another reason people get discouraged is they have no room in their family room for example, they have to make room, clear the table, put things away to make room to put out their paint supplies out, but with this “PAINT N CARRY” ALL YOU NEED IS A SMALL TABLE.

Also the tray is easy and light to carry, for example on a beautiful day to the park you can spend hours and hours of painting and its easy to travel with because the water jars can be closed with a lid (they could be coffee jars, pasta jars, anything with a lid) the jars could be glass or plastic, and also the paint containers have lids to protect the paint and keep them in place. so when your done painting all you have to do is clean your brushes with the clean water, close the lids of your paints, dump your water, throw away the Kleenex that you used when painting and it will be ready for the next time, easy, relaxing, joyful experience.

### BRIEF DESCRIPTION OF THE DRAWINGS (PICTURES)

### “Paint n Carry” —1—

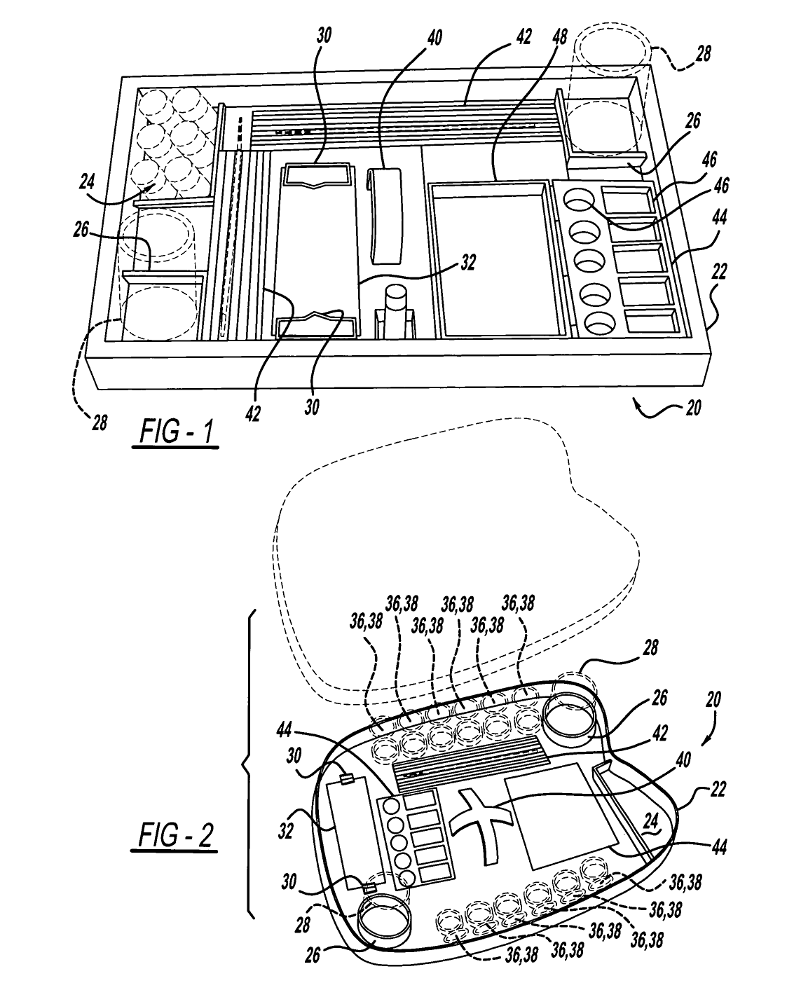

FIG. 1 its 24 in. wide×14 in. long.

FIG. 2 a palette with 10 wells, which is 7½ in. long 4½ in. wide

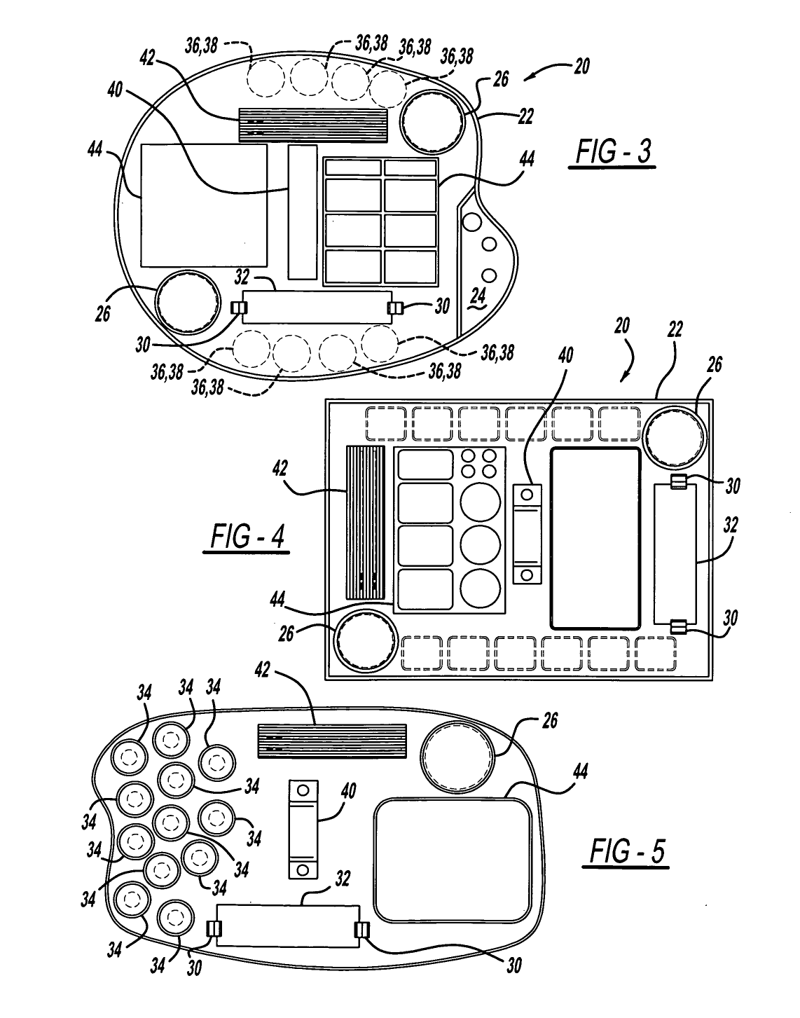

FIG. 3 the lid could be used like a palette when in use and it could be the lid cover to keep the paints moist and protected. it is 4½ in. wide and 7½ in. long, the same for the lid.

FIG. 4 the handle is 7 in. long and 1¼ wide.

FIG. 5 2/3½ in. clip across each other to put napkin or paper towel to hold it down from moving around to wipe, clean your brushes etc.

FIG. 6 14 in. brush rest to put your brushes on and its 2¼ long.

FIG. 7 also another spot to put your brushes on its 10 in. long and 2¼ in. wide

FIG. 8 a small palette to mix and blend your colors its 5 in. wide and 3½ in. long.

FIG. 9 a 3×3 in. square corner on the top right corner and left bottom corner area to put your water container, you need 2 jars (one for clean water and one for dirty water and its 2 in. high.

FIG. 10 6/4½ in. round containers to put extra paint with top lids and 1¼ in. high.

FIG. 11 also another spot to paint, a small palette is 6½ in. wide and 4 in. long.

### Paint n Carry #2

FIG. 1 a palette shape tray with a handle that holds all of your painting supplies to paint at home or wherever you like for example to the beach, to the library, art class, nursing home, traveling, teaching someone to paint etc. . . .

FIG. 2 the palette shape tray is 24½ wide×17¼ in. long, and 2 in. high (the outer border)

FIG. 3 the holder for the water jar is 12 in. round and 3 in. high you have two, one on the right top corner, and one at the bottom left corner, you need 2 holders for the jars, one for dirty water, one for clean water.

FIG. 4 the place where you put your brushes has a wavy surface to keep the brushes in place, its 11 in. long and 2½ in. wide.

FIG. 5 the handle is in a shape of a cross for easy clip and support, its 7½ long and 1 in. wide.

FIG. 6 the palette to paint on is 8¼ in. long and 6¾ in. wide.

FIG. 7 the palette with wells that has 10 wells is 7½ in. long and 4½ in. wide.

FIG. 8 the area to extra paint supply such as water spray, tubes, pencils etc. . . . , is 8 in. long and 1½ in. wide.

FIG. 9 2/1 in. clip across each other to hold your tissue cloth in place when in use.

### Paint n Carry #3

FIG. 1 this paint n carry palette shape is designed with kids in mind,

FIG. 2 its 18½ wide and 15½ in. long, the outer border is 2 in. high

FIG. 3 the place where you put your water jar in (water jar holder is 10 in. round and 2¼ in. high.

FIG. 4 the handle is 9 in. long and 1½ in. wide.

FIG. 5 the place to put your extra paint supplies such as water spray bottle pencils etc. . . . is 7 in. long.

FIG. 6 the smooth palette tray to paint on is 6 in. wide and 6¾ in. long.

FIG. 7 the 8 well palette is 5½ in. wide and 7 in. long.

FIG. 8 the place where you put your brushes on (brush rest) is a wavy surface to keep the brushes in place is 7½ in. wide and 2 in. long.

FIG. 9 the place where you put your tissue a rag to wipe paint etc. . . . is 2/1 in. clips across eachother to keep tissue in place.

FIG. 10 the clear see thru containers that holds your paint with attached lid are 2 in round and ½ in. deep and there is 8 of them. the bottom of these containers have Velcro backing for easy removal for cleaning and changing color etc. . . .

### “Paint n Carry” # 4

FIG. 1 this paint n carry is 21½ in. wide, 18½ in. long and the outer borders is 2 in. high.

FIG. 2 the water container holder is 12 in. round and 3 in. high you have 2, one for dirty water, one for clean water, one is on the top right corner, and one on the bottom left corner.

FIG. 3 a smooth palette is 12½ long and 6½ in. wide.

FIG. 4 the 12 paint containers are see thru with attached lids and are 2½ in wide and 2 in. long.

FIG. 5 the palette with wells is 12 in. long and 5½ wide.

FIG. 6 2/1 in. clips across each other to hold your rag or tissue in place when in use

FIG. 7 a place where you put your brushes (brush rest) is 12 in. long and 3 in. wide, it has a wavy surface to keep brushes in place.

FIG. 8 the handle is a square shape for easy crip and is 12 in. long and 1½ in. wide.

### “Paint n Carry” # 5

this paint and carry palette shape tray is designed for artist who like to paint out of the tubes to the palette to the canvas directly while the paint is still moist and every time they paint they would get the paint directly from the tubes

FIG. 1 its 24 in. wide and 15 in. long, and 2 in. high.

FIG. 2 it has one water jar holder that is 13½ in. round and 3 in. high.

FIG. 3 the palette to paint on is 8½ in. wide by 8½ in. long.

FIG. 4 the handle is 12 in. long,square shape for easy crip and and 1½ in. wide.

FIG. 5 the brush rest is 9 in. wide and 3½ in. long to put your brushes on, it has a wavy surface to keep the brushes in place.

FIG. 6 there is two 1 in. clips across each other to clip your rag or tissue in place when in use.

FIG. 7 there is 12 tube shape containers that are 6 in. round and 3 in. high to put your paint tubes in, the difference between these containers is they hold the tubes so you can paint directly from the tubes to the canvas, the other paint containers are see thru containers with lids that keeps your paints for weeks or months etc. . . . and all you have to do is spray them with water and could be used instantly, so this one is to paint from the tube directly to the palette to the canvas while the paint is fresh, moist like to use with gesso and other products.

### SUMMARY

### (“Paint-n-Carry)”

paint-n-carry is a new concept for artist to paint wherever they like, no need to get all of your art supply out, and then have to put everything back, it save you time, effort and stress. there are 5 different designed by nada asmaro but all have the same idea in mind, it would be made of strong, durable plastic,

1. palette # 1 is 24 in. w×14 L or wood or whatever is economical but yet durable.

2. palette # 2 is 24½ in. w×17½ in. L

3. palette # 3 is is 18½ in. w×15½ in. L

4. palette # 4 is 21½ in. w×18½ in. L

5. palette # 5 is 24 in. w×15 in. L

1. An apparatus for holding paint supplies, said apparatus comprising:
(a) a tray;
(b) a water jar holder attached to the tray;
(c) at least one clip attached to the tray, said clip being adapted to clip a rag to the tray; and
(d) a plurality of containers attached to the tray, each said container being shaped to hold a tube of paint tube.

2. The apparatus for holding paint supplies of claim 1, further comprising
(a) a handle attached to the tray;
(b) a brush rest attached to the tray, said brush rest having a wavy surface for keeping brushes in place; and wherein
(c) the tray is shaped as a painter's palette.

3. The apparatus for holding paint supplies of claim 2, further comprising ajar retained within the water jar holder and a rag clipped to the tray with the at least one clip.

4. The apparatus for holding paint supplies of claim 3, further comprising a paint palette set on the tray.

5. An apparatus for holding paint supplies, said apparatus comprising:
(a) a tray;
(b) a water jar holder attached to the tray;
(c) at least one clip attached to the tray, said clip being adapted to clip a rag to the tray; and
(d) a plurality of paint containers attached to the tray.

6. The apparatus for holding paint supplies of claim 5, further comprising
(a) a second jar holder, said jar holders being attached to the tray at opposite ends of a tray diagonal, whereby one jar holder may hold ajar of clean water and the other jar holder may hold a jar of dirty water; and
(b) a walled off area on the tray adapted to hold paint supplies.

7. The apparatus for holding paint supplies of claim 6, further comprising a paint palette set on the tray, said paint palette having a plurality of wells.

8. The apparatus for holding paint supplies of claim 5, further comprising a cross shaped handle attached to the center of the tray.

9. The apparatus for holding paint supplies of claim 5, wherein the paint containers are clear and wherein the paint containers are attached to the tray with Velcro.

10. An apparatus for holding paint supplies, said apparatus comprising:
(a) a tray;
(b) a water jar holder attached to the tray;
(c) at least one clip attached to the tray, said clip being adapted to clip a rag to the tray; and
(d) a paint palette set on the tray, said paint palette having a plurality of wells and said paint palette having a hinged lid, said hinged lid being adapted to seal paints within the paint palette when the lid is in a closed position and to allow the lid to be used as an additional paint palette when the lid is in an open position.

11. The apparatus for holding paint supplies of claim 10, further comprising
(a) a second jar holder, said jar holders being attached to the tray at opposite ends of a tray diagonal, whereby one jar holder may hold a jar of clean water and the other jar holder may hold a jar of dirty water; and
(b) a walled off area on the tray adapted to hold paint containers.

12. The apparatus for holding paint supplies of claim 11, further comprising
(a) a handle attached to the tray;
(b) a brush rest attached to the tray, said brush holder having a wavy surface for keeping brushes in place; and wherein
(c) the tray is shaped as a painter's palette.

13. The apparatus for holding paint supplies of claim 12, further comprising a jar retained within each water jar holder and a rag clipped to the tray with the at least one clip.

14. The apparatus for holding paint supplies of claim 10, further comprising one or more additional paint palettes set within the tray.

15. The apparatus for holding paint supplies of claim 6, further comprising a smooth surface paint palette.
